(19) United States
(12) Patent Application Publication
(10) Pub. No.: US 2017/0304998 A1
(43) Pub. Date: Oct. 26, 2017

(54) RATCHET HANDLE

(71) Applicant: Chia-Szu LIN, Taichung City (TW)

(72) Inventor: Chia-Szu LIN, Taichung City (TW)

(21) Appl. No.: 15/135,752

(22) Filed: Apr. 22, 2016

(51) Int. Cl. B25B 13/46

(52) U.S. Cl. CPC B25B 13/463

(57) ABSTRACT

A ratchet handle has a wrench body, a ratchet block, an elastic sheet and a ratchet. The ratchet block, the elastic sheet and the ratchet are received inside the wrench body. The ratchet block has a first end, a second end opposite the first end of the ratchet block, a first side, a second side opposite the first side of the ratchet block, and a sliding face. The sliding face is arranged on the second side of the ratchet block and is formed at the first end of the ratchet block. The elastic sheet has an assembling section assembled on the second side of the ratchet block. The assembling section extends toward the first end of the ratchet block and extends to a position on the sliding face, thereby pushing the ratchet block sufficiently to make the ratchet block and the ratchet free from slippage.

### BACKGROUND OF THE INVENTION

### 1. Field of the Invention

The present invention relates to a hand tool, and more particularly to a ratchet handle that is easily assembled and is free from slippage.

### 2. Description of Related Art

With reference to FIG. 5, a traditional ratchet handle 80 has a wrench body 81, a ratchet block 82, a compression spring 83, and a ratchet 84. The wrench body 81 has two opposite ends, an assembling hole 811, a receiving recess 812, and a spring receiving hole 813. The assembling hole 811 is defined in one of the two opposite ends of the wrench body 81 and has an inner surface. The receiving recess 812 is defined in the inner surface of the assembling hole 811 and has a bottom. The spring receiving hole 813 is defined in the bottom of the receiving recess 812. The ratchet block 82 is received in the receiving recess 812. The compression spring 83 is received in the spring receiving hole 813 and has two opposite ends. One of the two opposite ends of the compression spring 83 abuts against a bottom of the spring receiving hole 813. The other end of the compression spring 83 abuts against the ratchet block 82. The ratchet 84 is mounted in the assembling hole 811 and engages with the ratchet block 82.

The compression spring 83 of the traditional ratchet handle 80 abuts against the ratchet block 82, and the ratchet block 82 reciprocates along the receiving recess 812. The spring receiving hole 813 is defined in the bottom of the receiving recess 812 by a machine tool. However, the machine tool is difficult to reach into the receiving recess 813 and drill the spring receiving hole 813. The compression spring 83 is difficult to be inserted into the spring receiving hole 813 as well during assembly of the traditional ratchet handle. The problems of the traditional ratchet handle mentioned above increase the cost of machining and assembling.

With reference to FIG. 6, in order to resolve the above problems of the traditional ratchet handle 80, another kind of ratchet handle 90 is invented by the manufacturer. The conventional ratchet handle 90 has a wrench body 91, a ratchet block 92, an elastic sheet 93, and a ratchet 94. The wrench body 91 has an assembling hole 911 and a receiving recess 912. The ratchet block 92 and the elastic sheet 93 are received in the receiving recess 912. The ratchet 94 is mounted in the assembling hole 911. The ratchet block 92 of the conventional ratchet handle 90 has a first end 921 and a second end 922 opposite the first end 921 of the ratchet block 92. The first end 921 of the ratchet block 92 abuts against an inner surface of the receiving recess 912. The second end 922 of the ratchet block 92 is connected to the elastic sheet 93 and is pushed by the elastic sheet 93. The elastic sheet 93 abuts against the second end 922 of the ratchet block 92 and provides the ratchet block 92 with a force toward the ratchet 94 only, and cannot provide a sufficient lateral force to make the ratchet block 92 slide along the receiving recess 912. Therefore, slippage happens a lot between the ratchet block 92 and the ratchet 94.

To overcome the shortcomings of the conventional ratchet handle, the present invention provides a ratchet handle to mitigate or obviate the aforementioned problems.

### SUMMARY OF THE INVENTION

The main objective of the present invention is to provide a ratchet wrench that is easily assembled and is free from slippage. The ratchet handle comprises a wrench body, a ratchet block, an elastic sheet and a ratchet. The ratchet block, the elastic sheet and the ratchet are received inside the wrench body. The ratchet block has a first end, a second end opposite the first end of the ratchet block, a first side, a second side opposite the first side of the ratchet block, and a sliding face. The sliding face is arranged on the second side of the ratchet block and is formed at the first end of the ratchet block. The elastic sheet has an assembling section that is assembled on the second side of the ratchet block. The assembling section extends toward the first end of the ratchet block and to a position where the sliding face can push the ratchet block sufficiently and make the ratchet block and the ratchet free from slippage relative to each other.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a ratchet handle in accordance with the present invention;

FIG. 2 is an enlarged exploded perspective view of the ratchet handle in FIG. 1;

FIG. 3 is a partially enlarged perspective view of the ratchet handle in FIG. 1,

FIG. 4 is an enlarged operational side view in partial section of the ratchet handle in FIG. 1;

FIG. 5 is an exploded perspective view of a traditional ratchet handle; and

FIG. 6 is a cross sectional side view of a conventional ratchet handle.

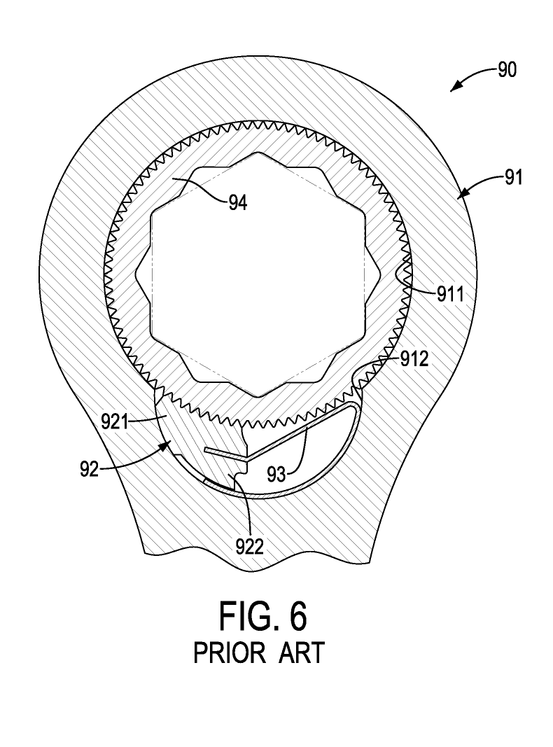

### DETAILED DESCRIPTION OF PREFERRED EMBODIMENT

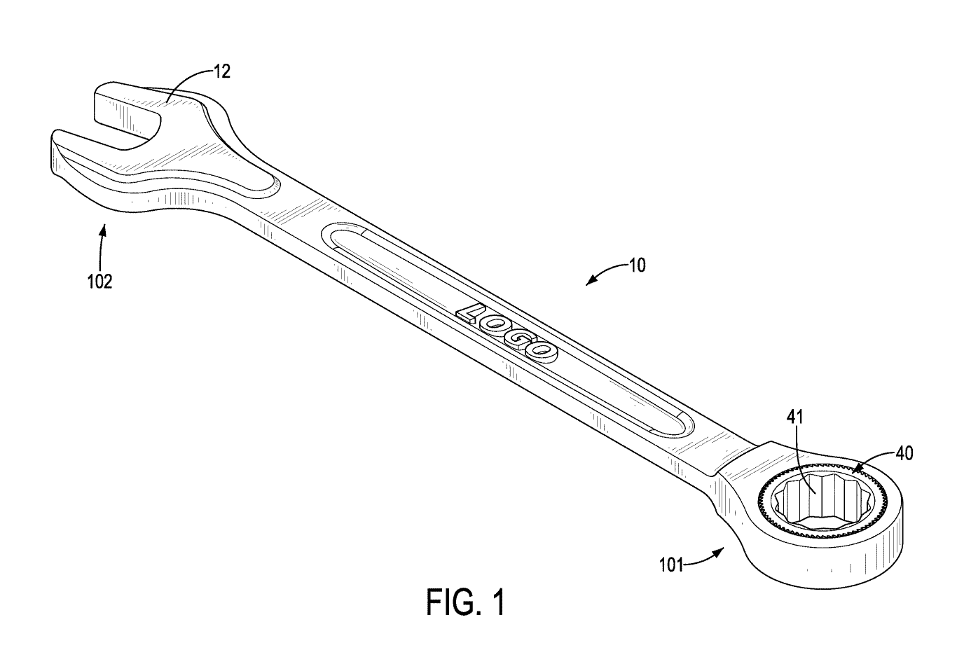

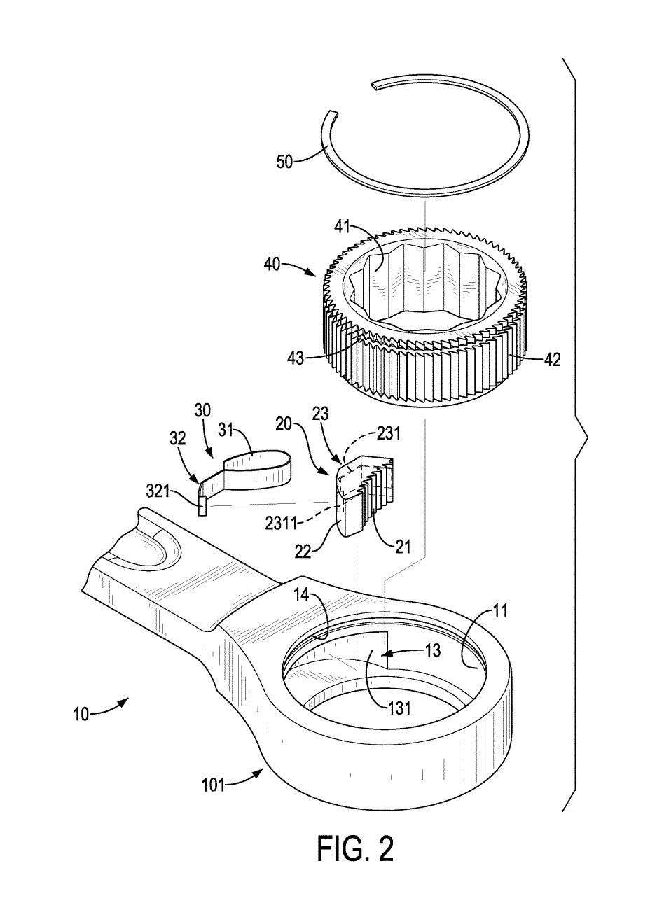

With reference to FIGS. 1 and 2, a ratchet handle in accordance with the present invention comprises a wrench body 10, a ratchet block 20, an elastic sheet 30, a ratchet 40, and a C-ring 50. The ratchet block 20, the elastic sheet 30, the ratchet 40, and the C-ring 50 are received inside the wrench body 10.

With reference to FIGS. 1 and 2, the wrench body 10 has a first end 101, a second end 102, a receiving hole 11, an open-end wrench 12, a receiving recess 13, and an annular groove 14. The first end 101 of the wrench body 10 has two opposite sides. The receiving hole 11 is defined through both of the two sides of the first end 101 of the wrench body 10 and has an inner surface. The open-end wrench 12 is formed at the second end 102 of the wrench body 10. The receiving recess 13 is adjacent to one of the two opposite sides of the first end 101 of the wrench body 10. The receiving recess 13 is defined in the inner surface of the receiving hole 11 and extends toward the second end 102 of the wrench body 10. The receiving recess 13 has a curved bottom 131. The annular groove 14 is adjacent to the other side of the first end 101 of the wrench body 10 and is annularly formed in the inner surface of the receiving hole 11.

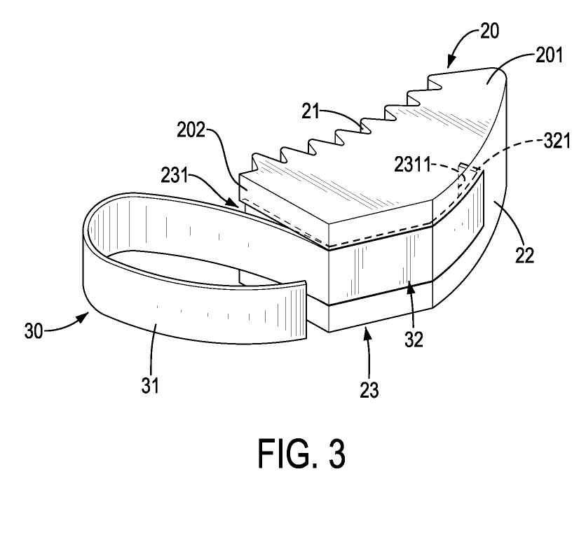

With reference to FIGS. 2 and 3, the ratchet block 20 is received in the receiving recess 13 and has a first end 201, a second end 202, a first side, a second side, a serrated portion 21, a sliding face 22, and an abutting portion 23. The first end 201 and the second end 202 of the ratchet block 20 are opposite each other. The first side and the second side of the ratchet block 20 are opposite each other. The serrated portion 21 is formed on the first side of the ratchet block 20 and has multiple serrated teeth. The sliding face 22 and the abutting portion 23 are both arranged on the second side of the ratchet block 20. The sliding face 22 is formed at the first end 201 of the ratchet block 20 and is curved to match the curved bottom 131 of the receiving recess 13. The abutting portion 23 is formed at the second end 202 of the ratchet block 20. The abutting portion 23 has a surface and an engaging recess 231. The engaging recess 231 is defined in the surface of the abutting portion 23 and extends from the second end 202 of the ratchet block 20 toward the first end 201 of the ratchet block 20 and has a terminal end located on the sliding face 22. The engaging recess 231 has a bottom and an engaging slit 2311. The engaging slit 2311 is arranged at the terminal end of the engaging recess 231 and is defined in the bottom of the engaging recess 231.

With reference to FIGS. 2 and 3, the elastic sheet 30 is received in the receiving recess 13 and has an elastic section 31 and an assembling section 32. The elastic section 31 is U-shaped and has a first end and a second end opposite the first end of the elastic section 31. The elastic section 31 abuts against the curved bottom 131 of the receiving recess 13. The first end of the elastic section 31 is received in the engaging recess 231 and abuts against the second side of the ratchet block 20. The assembling section 32 is connected at the first end of the elastic section 31. The assembling section 32 has a free end which is distal from the elastic section 31 and an engaging protrusion 321 formed at the free end of the assembling section 32. The assembling section 32 is engaged with the engaging recess 231 and abuts against the bottom of the engaging recess 231. The engaging protrusion 321 is mounted in the engaging slit 2311 of the engaging recess 231. The abutment between the assembling section 32 and the ratchet block 20 extends toward the first end 201 of the ratchet block 20 and to a position on the sliding face 22. Since the elastic sheet 30 abuts against over half of the second side of the ratchet block 20, the elastic sheet 30 can evenly push the ratchet block 20 and provide the ratchet block 20 with a force toward the receiving hole 11.

With reference to FIGS. 1 and 2, the ratchet 40 is received in the receiving hole 11. The ratchet 40 is annular and has an inner surface, an outer surface, a socket engaging portion 41, a serrated portion 42, and an engaging groove 43. The socket engaging portion 41 is formed on the inner surface of the ratchet 40. The serrated portion 42 is formed on the outer surface of the ratchet 40 and has multiple serrated teeth. The engaging groove 43 is annularly defined in and around the serrated portion 42 of the ratchet 40.

With reference to FIG. 2, the C-ring 50 is mounted in the annular groove 14 of the wrench body 10 and is engaged with the engaging groove 43 of the ratchet 40. The C-ring 50 can prevent the ratchet 40 from detaching from the receiving hole 11 of the wrench body 10.

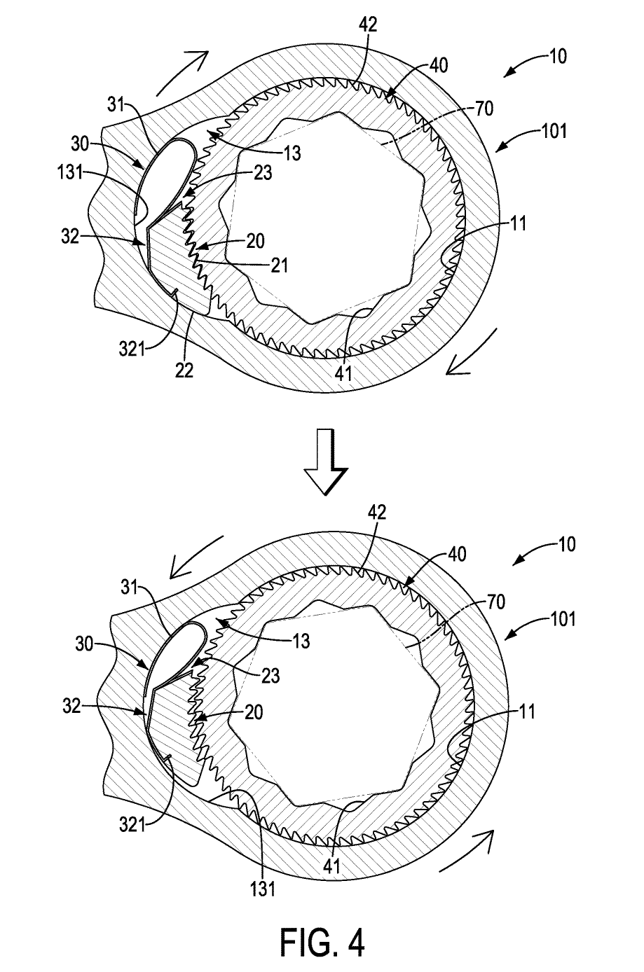

With reference to FIG. 4, in use, the ratchet 40 is mounted around a socket 70, and the socket engaging portion 41 is engaged with the socket 70. The ratchet block 20 abuts against the curved bottom 131 of the receiving recess 13, and the serrated portion 21 of the ratchet block 20 and the serrated portion 42 of the ratchet 40 are engaged with each other. Turning the wrench body 10 clockwise can make the ratchet 40 rotate the socket 70 to fasten a bolt. By turning the wrench body 10 counter-clockwise, the ratchet 40 is engaged with the ratchet block 20 and the sliding face 22 of the ratchet block 20 is gradually detached from the curved bottom 131 of the receiving recess 13. The elastic sheet 30 is compressed by the curved bottom 131 and the ratchet block 20. As the serrated portion 21 of the ratchet block 20 and the serrated portion 41 of the ratchet 40 are detached from each other, the ratchet block 20 is pushed by the elastic sheet 30 and slides along the curved bottom 131. The sliding face 22 of the ratchet block 20 abuts against the curved bottom 131 again. Then the serrated portion 21 of the ratchet block 20 and the serrated portion 42 of the ratchet 40 are engaged with each other, ready for a next fastening procedure.

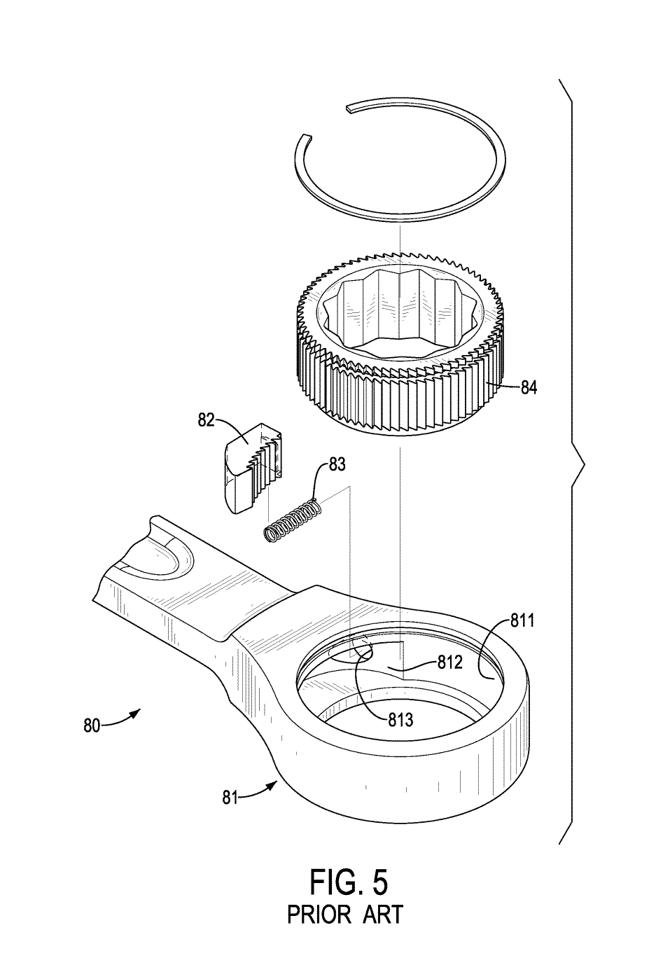

The elastic sheet 30 received in the receiving recess 13 and abutting against the ratchet block 20 can avoid inconvenience caused by machining a spring receiving hole 813 and assembling a compression spring 83 as shown in FIG. 5, and hence a production cost is saved. Most importantly, the assembling section 32 of the elastic sheet 30 is arranged along the engaging recess 231 of the abutting portion 23 and extends from the second end 202 of the ratchet block 20 toward the first end 201 of the ratchet block 20 to the sliding face 22. The assembling section 32 abuts against over half of the second side of the ratchet block 20, and provides the ratchet block 20 with a force toward the receiving hole 11 and a force that makes the sliding face 22 abut against the curved bottom 131 of the receiving recess 13. Therefore, the elastic sheet 30 pushes the ratchet block 20 sufficiently, makes the ratchet block 20 slide along the curved bottom 131 smoothly, and enables the serrated portion 21 of the ratchet block 20 and the serrated portion 42 of the ratchet 40 to be well engaged with each other and free from slippage relative to each other.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A ratchet handle comprising:
a wrench body having
a first end;
a second end opposite the first end of the wrench body;
a receiving hole defined through the first end of the wrench body and having an inner surface; and
a receiving recess defined in the inner surface of the receiving hole and having a curved bottom;
a ratchet block received in the receiving recess and having
a first end;
a second end opposite the first end of the ratchet block;
a first side;
a second side opposite the first side of the ratchet block and facing to the curved bottom;
a sliding face being curved, formed on the second side of the ratchet block and at the first end of the ratchet block, and selectively abutting against the curved bottom;
an elastic sheet received in the receiving recess and having
an elastic section being U-shaped, abutting against the curved bottom, and having
a first end; and
a second end opposite the first end of the elastic section; and
an assembling section connected at the first end of the elastic section, assembled on and abutting against the second side of the ratchet block, abutment between the assembling section and the ratchet block extending toward the first end of the ratchet block and to a position on the sliding face; and
a ratchet received in the receiving hole and engaged with the ratchet block.

2. The ratchet handle as claimed in claim 1, wherein
the ratchet block has an abutting portion arranged on the second side of the ratchet block, formed at the second end of the ratchet block, and having
a surface; and
an engaging recess formed in the surface of the abutting portion and having
a bottom; and
a terminal end located on the sliding face;
the first end of the elastic section is received in the engaging recess and abuts against the second side of the ratchet block; and
the assembling section of the elastic sheet is engaged with the engaging recess and abuts against the bottom of the engaging recess.

3. The ratchet handle as claimed in claim 2, wherein
the engaging recess has
an engaging slit arranged at the terminal end of the engaging recess and defined in the bottom of the engaging recess; and
the assembling section of the elastic sheet has
a free end distal from the elastic section; and
an engaging protrusion formed at the free end of the assembling section and engaged with the engaging slit.
